(19) United States
(12) Patent Application Publication
(10) Pub. No.: US 2010/0222104 A1
(43) Pub. Date: Sep. 2, 2010

(54) APPARATUS AND METHOD FOR OPERATING MOBILE TERMINAL THAT SUPPORTS DUAL MODE

(75) Inventor: Sang-Hyun LEE, Seoul (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/710,406

(22) Filed: Feb. 23, 2010

(30) Foreign Application Priority Data
Mar. 2, 2009 (KR) 10-2009-0017465

(51) Int. Cl. H04B 1/38

(52) U.S. Cl. 455/558

(57) ABSTRACT

An apparatus and a method for providing dual mode operation that stores two International Mobile System Identifier (IMSI) information in one SIM card is disclosed. The apparatus includes a controller and a SIM manager, wherein the recognizes mounting of one SIM card that stores two IMSI information, defines a first IMSI information corresponding to the SIM card as a master information, defines a second IMSI information as a second IMSI information, and transfers the second IMSI information to the SIM manager, wherein the SIM manager recognizes the second IMSI information as IMSI information of a SIM card not mounted, and recognizes that respective IMSI information has been separately stored as corresponding to having two SIM cards mounted.

### CLAIM OF PRIORITY

This application claims the benefit of an earlier patent application filed in the Korean Intellectual Property Office on Mar. 2, 2009 and assigned Serial No. 10-2009-0017465, entitled “Apparatus and Method for Operation Mobile Terminal that Supports Dual Mode,” the entire disclosure of which is hereby incorporated by reference in its entirety.

### BACKGROUND OF THE INVENTION

1. Field of the Invention

The present invention relates to the field of mobile terminals and more particularly, to an apparatus and a method for managing operation of a dual-mode mobile terminal.

2. Description of the Related Art

As communication technology continues to develop, network systems of various communication schemes are provided to the general public. Various types of network systems may be supported in a region or, for economic or technical considerations, only one network system may be supported. In addition, the network systems provide different fee structures depending on a service provider. For example, in the case of Russia, a fee is remarkably different for each network type depending on the region in which the network covers. Therefore, the conventional art has suggested a technique for allowing a user to selectively receive a desired network service according to the user's convenience by mounting two SIM cards on one mobile terminal and supporting corresponding networks.

At this point, the mobile terminal stores two international mobile subscriber identity (IMSI) information packets in one SIM card to select IMSI information according to a user's selection, or uses two main chips and supports two SIM cards as if two terminals were assembled in one case, to use IMSI information stored in each SIM card.

When two IMSI information packets are stored in one SIM card, as described above, to change to an unused IMSI information packet from the IMSI information packet in use, a SIM refresh process of restarting a terminal operation internally according to a user's selection and changing IMSI information must be performed.

In addition, a mobile terminal that supports two SIM cards and uses IMSI information stored in each SIM card must separately store IMSI information corresponding to each SIM card, and then use the relevant IMSI information. That is, the mobile terminal mounts two SIM cards, each storing one IMSI information, and stores and uses IMSI information for each SIM card separately

Therefore, there is a need for better way of enabling a mobile terminal to support two SIM cards via one SIM card.

### SUMMARY OF THE INVENTION

An exemplary aspect of the present invention is to provide an apparatus and a method for using two IMSI information using one SIM card in a mobile terminal without the need for restarting the terminal operation internally during switching.

Another exemplary aspect of the present invention is to provide an apparatus and a method for defining different IMSI information excluding IMSI information to be used for a SIM card that stores a plurality of IMSI information, as information of a different SIM card in a mobile terminal.

Still another exemplary aspect of the present invention is to provide an apparatus and a method for selecting IMSI information without a SIM refresh process when changing among a plurality of IMSI information stored in a SIM card in a mobile terminal.

In accordance with an exemplary aspect of the present invention, an apparatus for operating a mobile terminal that supports a dual mode is provided. A mobile terminal that supports two Subscriber Identity Module (SIM) cards recognizes mounting of one SIM card that stores two International Mobile System Identifier (IMSI) information, includes: a controller for defining a first IMSI information corresponding to the SIM card as a master information, defining a second IMSI information as second IMSI information, and transferring the second IMSI information to a SIM manager; which recognizes the second IMSI information as IMSI information of a SIM card not mounted, and recognizes that respective IMSI information has been separately stored as being associated with two corresponding SIM cards.

In accordance with another exemplary aspect of the present invention, a method for operating a mobile terminal that supports a dual mode is provided. The method includes: defining IMSI information corresponding to the SIM card as master information, and defining the other IMSI information as second IMSI information; when the mobile terminal that supports two Subscriber Identity Module (SIM) cards recognizes mounting of one SIM card that stores two International Mobile System Identifier (IMSI) information, and recognizing the second IMSI information as IMSI information of a SIM card not mounted, and recognizing that respective IMSI information has been separately stored as being associated with two corresponding SIM cards.

Other exemplary aspects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other exemplary aspects, features and advantages of certain exemplary embodiments of the present invention will become more apparent from the following description taken in conjunction with the accompanying drawings in which:

FIG. 1 is a block diagram illustrating a mobile terminal according to an exemplary embodiment of the present invention; and

FIG. 2 is a flowchart illustrating an initial operation procedure of a mobile terminal according to an exemplary embodiment of the present invention.

Throughout the drawings, like reference numerals will be understood to refer to like parts, components and structures.

### DETAILED DESCRIPTION OF THE INVENTION

The following description, with reference to the accompanying drawings, is provided to assist in a comprehensive understanding of exemplary embodiments of the invention as defined by the appended claims. The description includes various specific details to assist a person of ordinary skill the art in understanding the claimed invention, but these are to be regarded as merely exemplary. Accordingly, those of ordinary skill in the art will recognize that various changes and modifications of the illustrative examples described herein can be made without departing from the spirit of the invention and the scope of the appended claims. For the purposes of clarity and simplicity, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural references unless the context clearly dictates otherwise. Thus, for example, a reference to “a component surface” includes reference to one or more of such surfaces.

By the term “substantially” it is typically meant that the recited characteristic, parameter, or value need not be achieved exactly, but that deviations or variations, including but, in no way limited to, for example, tolerances, measurement error, measurement accuracy limitations and other factors known to persons of ordinary skill in the art, may occur in amounts that do not preclude the effect the characteristic was intended to provide.

Exemplary embodiments of the present invention provide an apparatus and a method for providing an effect of using two SIM cards in a mobile terminal that stores two IMSI information in one SIM card. Here, the SIM card denotes an integrated-type semi-conductor memory device (i.e., a chip) for storing authorization information for using a mobile phone roaming service and personal information of a subscriber. A subscriber can use a mobile communication terminal with his phone number in any region regardless of mobile phone technology standards by inserting an appropriate SIM card into the mobile communication terminal.

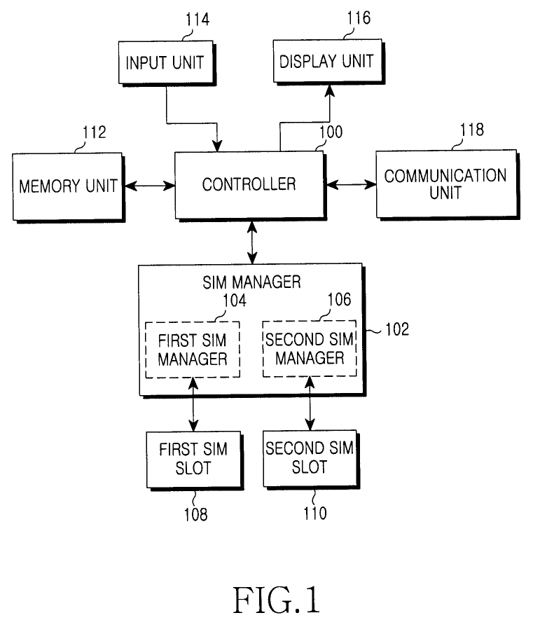

FIG. 1 is a block diagram illustrating a mobile terminal according to an exemplary embodiment of the present invention.

Referring to FIG. 1, the mobile terminal includes a controller 100, a SIM manager 102, a first SIM slot 108, a second SIM slot 110, a memory unit 112, an input unit 114, a display unit 116, and a communication unit 118. The SIM manager 102 may include a first SIM manager 104 and a second SIM manager 106 associated with first SIM slot 108 and second SIM slot 110.

First, the controller 100 of the mobile terminal controls an overall operation of the mobile terminal. For example, the controller 100 performs processes for the control and operation of voice communication, data communication and other ancillary functions, such as camera, date calendar, etc. In addition to the general functions performed by the controller 100, when recognizing that one SIM card that stores two IMSI information is mounted, the controller 100 recognizes the two IMSI information as information being associated with two SIM cards, so that one SIM card is used for the management of two IMSI information.

That is, when recognizing that one SIM card that stores two IMSI information is mounted, the controller 100 uses one of the two IMSI information as a first IMSI information, which is designated as a master information, and defines the other (unused) IMSI information as a second IMSI information. After that, the controller 100 transfers the second IMSI information to the second SIM manager 106 as if managing a different (second) SIM card. That is, the controller 100 processes the second IMSI data so that it appears that a second SIM card has been mounted in the second SIM slot 110.

When a SIM card is mounted in the SIM slot (e.g., the first SIM slot 108) under control of the controller 100, the SIM manager 102 determines what IMSI information is stored on the mounted SIM card. When it is determined that two IMSI information are stored on the SIM card, the SIM manager 102 transfers one IMSI information to the second SIM manager, which manages the second SIM slot 110, as if a SIM card has been mounted in the unused SIM slot (e.g., SIM slot 110).

In this exemplary case, the first SIM manager 104 of the SIM manager 102 manages a SIM card mounted in the first SIM slot 108, and the second SIM manager 106 manages a SIM card mounted in the second SIM slot 110. However, it would be recognized that the designations of first and second slots and managers are provided only for the description of the invention and that these designations may be interchanged without altering the scope of the invention.

The first SIM slot 108 and the second SIM slot 110 allow mounting of SIM cards storing a user's various information and supported network information. The first and second SIM cards (not shown) are attachable to and detachable from the first SIM slot 108 and the second SIM slot 110, respectively. The first and second SIM slots may also be attachable to and detachable from the mobile terminal, have embedded processors and memory chips, and store a user's various information and supported network information.

The memory unit 112 includes at least one of a Read Only Memory (ROM), Random Access Memory (RAM), and flash ROM. The ROM stores microcode of a program that may be used by the controller 100 to execute processes for the control of the SIM manager 102. The ROM may further store various reference data.

The RAM is a working memory of the controller 100 and stores temporary data generated while various programs are being executed. In addition, the flash ROM stores various updatable data for storage such as phone books, calling messages, received messages, etc.

The input unit 114 includes a plurality of function keys such as numerical key buttons of 0 to 9, a menu button, a delete button, an OK button, a TALK button, an END button, an Internet connection button, navigation key (or direction key) buttons, character input keys, etc. The input unit 114 provides key input data (e.g., Power On) corresponding to a key pressed by a user to the controller 100.

The display unit 116 displays status information, a limited number of characters, a large amount of moving images and still images, etc. occurring during an operation of the mobile terminal. The display unit 116 may be a color Liquid Crystal Display (LCD).

The communication unit 118 transmits/receives radio signals of data input/output via an antenna (not shown). For example, when transmitting data, the communication unit 118 channel-codes and spreads the data to be transmitted, performs a Radio Frequency (RF) process, and transmits the same, in a CDMA type system. When receiving a signal, the communication unit 118 converts the received RF signal into a baseband signal, despreads and channel-decodes the baseband signal to recover data (i.e., CDMA). Similar transmitting and receiving processing is performed for a GSM type system. CDMA and GSM type transmitting/receiving systems are well-known in the art and need not be disclosed in detail herein.

The role of the SIM manager 102 can be performed by the controller 100 of the mobile terminal, but separate configuration and illustration of the SIM manager 102 is an exemplary configuration for convenience in description and not for limiting the scope of the present invention. A person of ordinary skill in the art would understand various modifications can be made within the scope of the present invention to incorporate all or some of the functions of the SIM manager 102 may be incorporated into the controller 100.

As would be recognized, the ISMI data on the SIM card may be included in well known formats and, thus, need not be discussed in detail herein. However, the SIM card may include additional information which may be to define the location of the second ISMI data on the SIM card. For example, the additional data may be represent a pointer(s), in a designated location(s) on the SIM card, that directs the controller to one or more designated areas that contain the ISMI data.

Up to now, description has been made to an apparatus for providing an effect of using two SIM cards in a mobile terminal that stores two IMSI information in one SIM card according to an exemplary embodiment of the present invention. Hereinafter, a method for providing an effect of using two SIM cards in a mobile terminal that stores two IMSI information on one SIM card using the apparatus according to an exemplary embodiment of the present invention is now described.

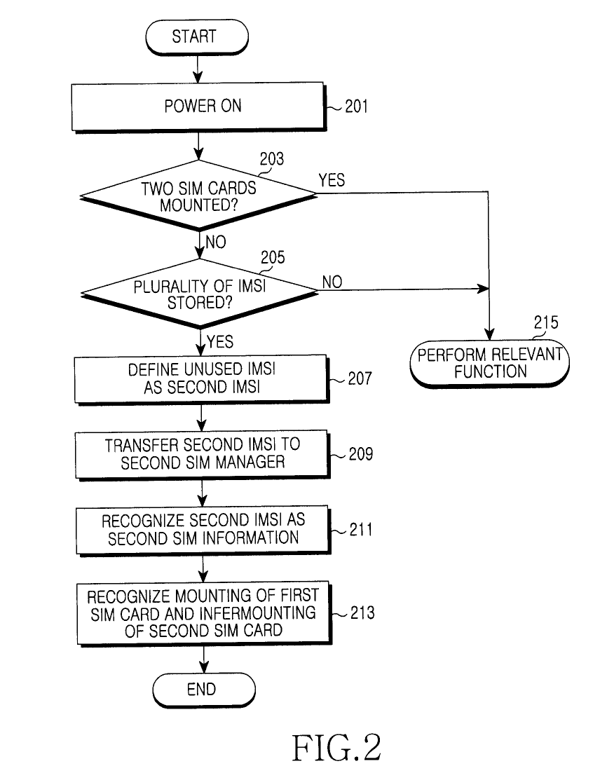

FIG. 2 is a flowchart illustrating an initial operation procedure of a mobile terminal according to an exemplary embodiment of the present invention.

Referring to FIG. 2, when power is applied in step 201, the controller 100 of the mobile terminal determines, in step 203, whether two SIM cards are mounted. When it is determined that the two SIM cards are mounted, the controller 100 performs a relevant function (e.g., determines a SIM card set to be a master SIM card between the two mounted SIM cards, and performs an operation of the mobile terminal), in step 215. Such operations may, for example, be performing a voice communication call using the information stored on the master SIM card.

However, when it is determined, in step 203, that the two SIM cards are not mounted, (i.e., one SIM card is mounted in the mobile terminal), the controller 100 determines whether a plurality of IMSIs are stored on the mounted one SIM card in step 205.

When it is determined, in step 205, that the one SIM card stores only one IMSI, the controller 100 performs a relevant function (e.g., an operation of the mobile terminal using one IMSI) as previously described in step 215.

However, when it is determined, in step 205, that the one SIM card stores two IMSIs, the controller 100 controls the SIM manager 102 to use a first IMSI corresponding to the mounted SIM card as master IMSI information, and defines the second (unused) IMSI as a second IMSI in step 207. The controller then controls the SIM manager 102 to transfer the second IMSI to the second SIM manager 106.

For the purposes of describing the invention claims, the SIM card that stores the two IMSIs is mounted in the first SIM slot 108, and the controller 100 controls the first SIM manager 104 to use an IMSI corresponding to the SIM card as master IMSI information, and defines the other (unused IMSI) as a second IMSI. That is, an IMSI unused by the mobile terminal is defined as information of a SIM card of a different slot.

At this point, when storing two IMSIs in one SIM card, the conventional mobile terminal should perform a SIM refresh process of changing IMSI information according to a user's selection in order to use different IMSI information after providing a service using one IMSI information. A mobile terminal according to an exemplary embodiment of the present invention uses two IMSI information without a SIM refresh process.

Returning to FIG. 2, the controller 100 allows the second SIM manager 106 to recognize the transferred second IMSI as IMSI information stored in a second SIM card in step 211, and then infers that SIM cards storing corresponding IMSI information have been mounted in the two SIM slots of the mobile terminal to allow services using respective IMSI information to be used in step 213.

That is, a mobile terminal according to an exemplary embodiment of the present invention can resolve a problem of having to perform a SIM refresh process of selecting IMSI information according to a user's selection in order to use respective IMSI information by performing the above-described operations and storing two IMSI information in one SIM card in an existing mobile terminal.

After that, the controller 100 ends the algorithm according to an exemplary embodiment of the present invention.

As described above, an exemplary embodiment of the present invention makes using a service that uses each IMSI information possible by defining unused information of two IMSIs as second IMSI information and providing the second IMSI information to a SIM manager as if managing a second SIM card in order to provide an effect of using two SIM cards to a mobile terminal. That is, there is no need for a refresh to switch from one IMSI to another which must be performed in a conventional technology wherein there are two IMSI information in one SIM card. This is because the present invention provides an environment as if there are two SIM cards after recognizing that there are two IMSI information in one SIM card. Hence, there is no need to refresh when there are two SIM cards as in the conventional technology. As the present invention needs only one SIM card, which includes two separate IMSI. Thus, there is no need to have two cards to have the same as in the conventional technology. Note that method to identify there are two IMSI information in one SIM card is known technology, thus description thereof is omitted.

As would be recognized, the above-described methods and controller 100, according to the present invention, can be realized in hardware or as software or computer code that can be stored in a recording medium such as a CD ROM, an RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. As would be recognized by those skilled in the art, when a general purpose computer is loaded with, or accesses, software or code for implementing the processing shown herein, the general purpose computer is transformed into a special purpose computer that may at least perform the processing shown herein.

Although the invention has been shown and described with reference to certain exemplary embodiments thereof, it will be understood by those skilled in the art that various changes in form and details may be made therein without departing from the spirit and scope of the invention as defined by the appended claims and their equivalents. Therefore, the scope of the present invention should not be limited to the above-described embodiments but should be determined by not only the appended claims but also the equivalents thereof.

What is claimed is:

1. An apparatus for operating a mobile terminal supporting a dual mode operation, comprising:
means for:
recognizing as if there are two subscriber identity module (SIM) cards when there are two International Mobile System Identifier (IMSI) information stored in a single SIM card; and
storing, separately, the two IMSI information as if the two IMSI information are stored as corresponding to two SIM cards.

2. The apparatus of claim 1, wherein said means comprises:
a controller; and a SIM manager,
the controller for:
recognizing mounting of the first SIM card which stores two IMSI information,
defining a first one of the two IMSI information corresponding to the first SIM card as a master information,
defining a second one of the two IMSI information as second IMSI information, and
transferring the second IMSI information to the SIM manager; and
the SIM manager for:
recognizing the second IMSI information as IMSI information of an unmounted second SIM card, and
recognizing that respective ones of the two IMSI information has been separately stored as IMSI information corresponding to the first SIM card and the unmounted second SIM card.

3. The apparatus of claim 2, wherein the controller recognizes the stored IMSI information being associated with the first SIM card and the unmounted second SIM card, respectively, and provides services that use respective IMSI information.

4. The apparatus of claim 2, wherein the apparatus changes IMSI information without a SIM refresh process after recognizing that respective two IMSI information has been separately stored two SIM card.

5. A method for operating a mobile terminal that supports a dual mode, the method comprising:
mounting a first Subscriber Identity Module (SIM) card;
recognizing there are two SIM cards when there are a first and a second International Mobile System Identifier (IMSI) information stored on the first SIM card; and
storing, separately, the first and second IMSI information as if the first and second IMSI information are stored on corresponding ones of the first and a second SIM card, the second SIM card not being mounted.

6. The method of claim 5, comprising:
defining IMSI information corresponding to the first SIM card as IMSI master information, and
defining the IMSI information corresponding to the unmounted second SIM card as second IMSI information; and
storing the first and second IMSI information as respective IMSI information associated with the first mounted SIM card and the second unmounted SIM card.

7. The method of claim 6, further providing services that use respective IMSI information.

8. The method of claim 6, wherein the defining the IMSI information corresponding to the unmounted second SIM card comprises:
defining the IMSI information corresponding to the unmounted second SIM card as IMSI information for an associated slot in order to use the IMSI information corresponding to the unmounted second SIM card as the IMSI information corresponding to the associated slot.

9. The method of claim 6, further comprising changing IMSI information without a SIM refresh process after recognizing that respective two IMSI information has been separately stored two SIM card.

10. A mobile terminal including a first slot and a second slot, each of the slots in communication with a corresponding SIM manager, the terminal including;
a processor in communication with a memory, the memory including code, which when accessed by the processor, causes the processor to:
recognize mounting of a first Subscriber Identification Module (SIM) in the first slot;
determining presence of a first IMSI and a second IMSI information on said first SIM;
extracting the first and second IMSI information from said first module;
storing the first IMSI information as a master IMSI information; and
storing the second IMSI information as a second IMSI information, wherein the second IMSI information is associated with a SIM in the second slot and accessible by the corresponding SIM manager.

11. The terminal of claim 10, further comprising:
determining an unmounted SIM card in the second slot.

12. The terminal of claim 10, further comprising:
changing between the first ISMI information and the second ISMI information without a refresh process after recognizing that respective two IMSI information has been separately stored two SIM card.
